(19) United States
(12) Patent Application Publication
(10) Pub. No.: US 2018/0249775 A1
(43) Pub. Date: Sep. 6, 2018

(54) Article of Apparel

(71) Applicant: Under Armour, Inc., Baltimore, MD (US)

(72) Inventors: Noah Pitchforth, Baltimore, MD (US); Katherine Maiva, Baltimore, MD (US); Maxi Roberts, Baltimore, MD (US)

(21) Appl. No.: 15/907,442

(22) Filed: Feb. 28, 2018

Related U.S. Application Data
(60) Provisional application No. 62/466,086, filed on Mar. 2, 2017.

(51) Int. Cl. A41D 27/00; A41B 1/08; G09B 19/00; A41D 1/02; A41D 1/04; A41D 27/10

(52) U.S. Cl. CPC A41D 27/00; A41B 1/08; G09B 19/0038; A41D 1/02; A41D 2400/00; A41D 27/10; A41D 2500/10; A41D 2600/10; A41D 2300/22; A41D 1/04

(57) ABSTRACT

An article of clothing includes a torso portion, a first sleeve, and a second sleeve. The first sleeve is coupled to the first side of the torso portion. The second sleeve is coupled to the second side of the torso portion. The torso portion includes a plurality of resilient bands, one disposed diagonally on the front of the torso portion, and two diagonally disposed on the rear of the torso portion such that the two bands intersect one another. The first sleeve and the second sleeve each also include a resilient band. The front band of the torso and one of the rear bands of the torso may have a first modulus of elasticity. The second rear band of the torso and the band of the first sleeve may have a second modulus of elasticity. The band of the second sleeve may have a third modulus of elasticity.

### CROSS-REFERENCE TO RELATED APPLICATIONS

This application claims priority under 35 U.S.C. 119(e) to U.S. Provisional Patent Application Ser. No. 62/466,086, entitled “Article of Apparel”, filed Mar. 2, 2017, the disclosure of which is incorporated herein by reference in its entirety for all purposes.

### FIELD OF THE INVENTION

The present invention relates to an article of apparel and, in particular, a shirt that enhances positional feedback.

### BACKGROUND OF THE INVENTION

Proper technique and form, coupled with muscle coordination, are required by athletes to perform various activities. For example, in archery, an athlete raises a bow such that their downrange arm is level with the target, while the elbow of their drawing arm is positioned such that the drawing arm is level with (or slightly above) their shoulder. Accordingly, the ability of an athlete to continuously repeat technique and form enables an athlete to compete at a high level. Thus, it would be desirable to provide a garment configured to assist an athlete obtain proper positioning during an athletic activity.

### BRIEF SUMMARY OF THE INVENTION

An article of clothing includes a torso portion, a first sleeve, and a second sleeve. The first sleeve is coupled to the first side of the torso portion. The second sleeve is coupled to the second side of the torso portion. The torso portion may include a plurality of resilient bands, one disposed diagonally on the front of the torso portion, and two diagonally disposed on the rear of the torso portion such that the two bands intersect one another. The first sleeve and the second sleeve may each also include a resilient band. The front band of the torso and one of the rear bands of the torso may have a first modulus of elasticity. The second rear band of the torso and the band of the first sleeve may have a second modulus of elasticity. The band of the second sleeve may have a third modulus of elasticity. The second modulus of elasticity may be greater than the first modulus of elasticity. Both the first and second moduli of elasticity may be greater than the third modulus of elasticity.

In another embodiment, an article of clothing includes a torso portion, a first sleeve, and a second sleeve. The torso portion may have a front side, a rear side, a first side, and a second side. The torso portion may further comprise a first resilient band. The first sleeve may be coupled to the first side of the torso portion, and may include a second resilient band. The third sleeve may be coupled to the second side of the torso portion, and may include a third resilient band. The first resilient band may have a first modulus of elasticity, the second resilient band may have a second modulus of elasticity, and the third resilient band may have a third modulus of elasticity.

In yet another embodiment, an article of clothing includes a torso portion, a first sleeve, and a second sleeve. The torso portion may be constructed of a base material and a first resilient band. The first sleeve may be coupled to a first side of the torso portion, and may be constructed of the base material and a second resilient band. The third sleeve may be coupled to a second side of the torso portion, and may be constructed of the base material and a third resilient band. The first resilient band may be integrally knitted with the base material of the torso portion, the second resilient band may be integrally knitted with the base material of the first sleeve, and the third resilient band may be integrally knitted with the base material of the second sleeve.

In another embodiment, an article of clothing includes a torso portion, a first sleeve, a second sleeve, and six resilient bands. The torso portion may have a front side, a rear side, a top side, a bottom side, a first side, and second side. The first sleeve may have a distal end and a proximal end, where the first sleeve may be coupled to the first side of the torso portion at the proximal end of the first sleeve. The second sleeve may have a distal end and a proximal end, the second sleeve may be coupled to the second side of the torso portion at the proximal end of the second sleeve. The first resilient band may have a first end, a second end, and a first modulus elasticity. The first resilient band may extend along the first sleeve with the first end of the first resilient band disposed adjacent to the proximal end of the first sleeve and the second end of the first resilient band disposed at a position along the first sleeve between the proximal end of the first sleeve and the distal end of the first sleeve. The second resilient band may have a first end, a second end, and a second modulus of elasticity. The second resilient band may extend across the rear side of the torso along the top side and along the second sleeve with the first end of the second resilient band disposed adjacent to the proximal end of the first sleeve, and the second end of the second resilient band being disposed adjacent the distal end of the second sleeve. The third resilient band may have a first end, a second end, and a third modulus of elasticity. The third resilient band may extend across the front side of the torso portion with the first end of the third resilient band disposed proximate to the top side and the second side of the torso portion and the second end of the third resilient band disposed proximate to the bottom side and the first side of the torso portion. The fourth resilient band may have a first end, a second end, and the third modulus of elasticity. The fourth resilient band may extend across the rear side of the torso portion with the first end of the fourth resilient band disposed proximate to the top side and the second side of the torso portion and the second end of the fourth resilient band disposed proximate to the bottom side and the first side of the torso portion. The fifth resilient band may have a first end, a second end, and the first modulus of elasticity. The fifth resilient band may extend across the rear side of the torso portion and intersect the fourth resilient band with the first end of the fifth resilient band disposed proximate to the top side and the first side of the torso portion and the second end of the fifth resilient band disposed proximate to the bottom side and the second side of the torso portion. The sixth resilient band may extend through the front side, rear side, first side, and second side of the torso portion proximate to the bottom side of the torso portion. The sixth resilient band having the third modulus of elasticity. The first modulus of elasticity may be greater than the second modulus of elasticity and the third modulus of elasticity. The third modulus of elasticity may be greater than the second modulus of elasticity.

### BRIEF DESCRIPTION OF THE SEVERAL VIEWS OF THE DRAWINGS

FIG. 1A illustrates a front view of a garment in accordance with an embodiment of the present invention.

FIG. 1B illustrates a rear view of the embodiment of the garment illustrated in FIG. 1A.

FIG. 2A illustrates a front view of the torso portion of the embodiment of the garment illustrated in FIG. 1A.

FIG. 2B illustrates a rear view of the torso portion of the embodiment of the garment illustrated in FIG. 1A.

FIG. 3A illustrates a first side of the torso portion of the embodiment of the garment illustrated in FIG. 1A.

FIG. 3B illustrates a second side of the torso portion of the embodiment of the garment illustrated in FIG. 1A.

FIG. 4 illustrates a rear view of a first sleeve of the embodiment of the garment illustrated in FIG. 1A.

FIG. 5 illustrates a rear view of the second sleeve of the embodiment of the garment illustrated in FIG. 1A.

FIGS. 6A-6C illustrate views of a user posing in a shooting stance while wearing the embodiment of the garment illustrated in FIG. 1A.

FIGS. 7A-7C illustrate views of a user posing in a shooting stance while wearing a second embodiment of the present invention.

Like reference numerals have been used to identify like elements throughout this disclosure.

### DETAILED DESCRIPTION OF THE INVENTION

In the following detailed description, reference is made to the accompanying figures which form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The terms “comprising,” “including,” “having,” and the like, as used with respect to embodiments of the present disclosure, are synonymous.

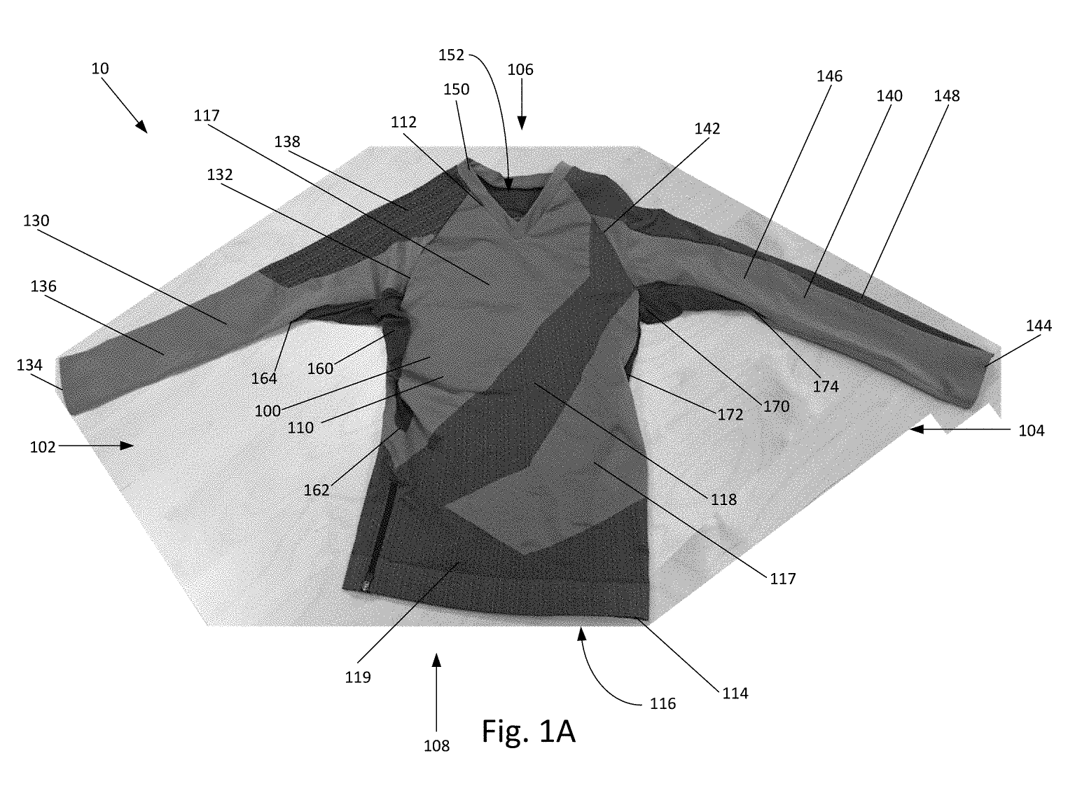

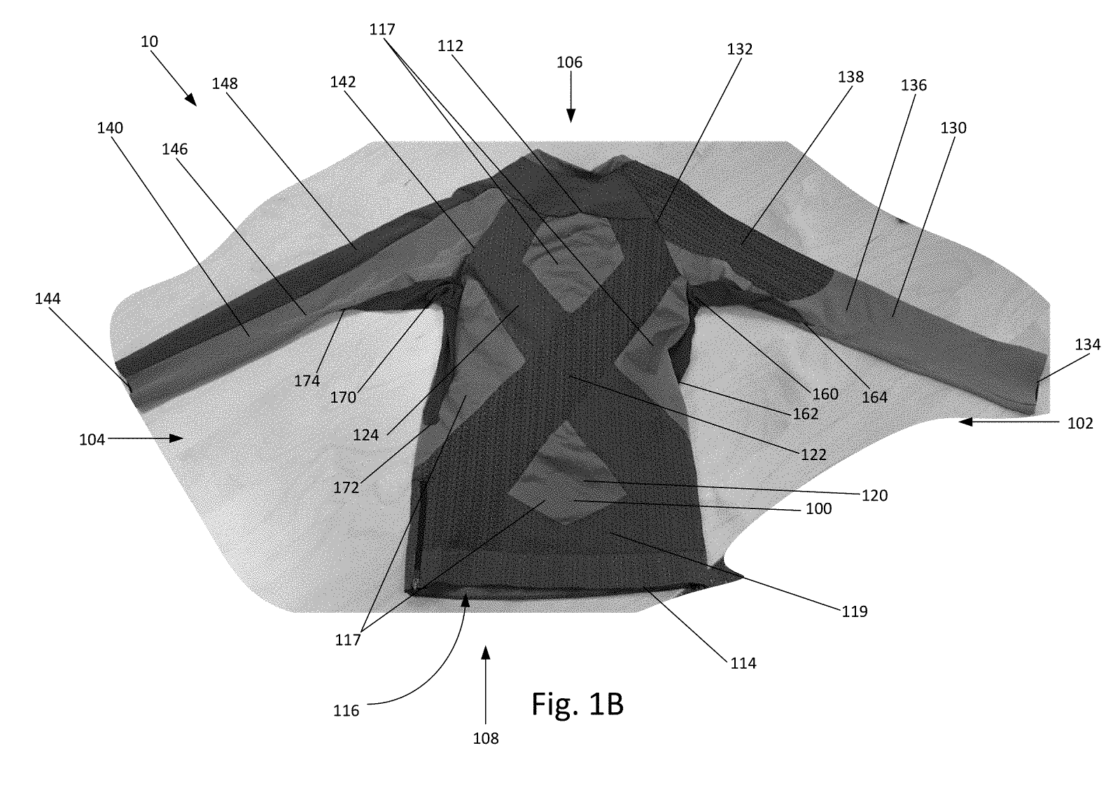

Referring to FIGS. 1A, 1B, 2A, 2B, 3A, 3B, 4, and 5 illustrated is a first embodiment of a garment that can be worn by a person, where the garment illustrated is a shirt 10. The term shirt may refer to any type of garment top typically worn by people, including, but not limited to, shirts (e.g., dress shirts, T-shirts, etc.), blouses, sweaters, jackets, coats, etc. The shirt 10 contains a body or torso portion 100 having a first (e.g., right) side 102, a second (e.g., left) side 104 oriented opposite the first side 102, a top side 106, and a bottom side 108 oriented opposite the top side 106. The torso portion 100 further includes a front side 110 (illustrated in FIG. 1A) and a rear side 120 (illustrated in FIG. 1B) opposite the front side 110.

As described herein, portions of the garment are formed via a knitting process. However, it is noted that the garment can also be formed by any other suitable process (e.g., weaving, forming nonwoven textiles, knitting and/or any combinations thereof).

In the embodiment illustrated in FIGS. 1A and 1B, the shirt 10 further includes a first sleeve 130 and a second sleeve 140. The first sleeve 130 extends from the first side 102 of the torso portion 100 proximate to the top side 106 of the torso portion 100, while the second sleeve 140 extends from the second side 104 of the torso portion 100, opposite first sleeve 130. The first sleeve 130 includes a proximal end 132 and a distal end 134, while the second sleeve 140 similarly includes a proximal end 142 and a distal end 144. The sleeves 130, 140 may be coupled to the torso portion 100 of the shirt 10 at their proximal ends 132, 142, respectively. In the embodiment illustrated, the sleeves 130, 140 may be coupled to the torso portion 100 of the shirt 10 as raglan sleeves. In another embodiment, the sleeves 130, 140 may be coupled to the torso portion 100 of the shirt 10 in any other manner (i.e., set-in sleeve, fitted sleeve, etc.).

As illustrated in FIGS. 1A and 1B, the first sleeve 130 includes a first portion 136 and a second portion 138. The second sleeve 140 also includes a first sleeve portion 146 and a second sleeve portion 148. As further described below, the first and second portions 136, 138 of the first sleeve 130 and the first and second portions 146, 148 of the second sleeve 140 may each have a different modulus of elasticity (also referred to as an elastic modulus). Generally, a material that is stiffer (e.g., less resilient or more resistant to stretching) will have a greater modulus of elasticity. Thus, a material incorporated into the shirt 10 (e.g., in the form of a band as described herein) and having a greater modulus of elasticity will generally provide a greater degree of resistance to movement of a user's body part in stretching such material in relation to another material having a smaller modulus of elasticity. A stiffer material or material more resistant to stretch (i.e., a material having a larger elastic modulus) will also have a lower degree of elasticity in relation to a material that is less stiff or more susceptible/easier to stretch (i.e., a material having a smaller elastic modulus).

The torso portion 100 further includes a top edge 112 proximate to the top side 106 of the torso portion 100 and a bottom edge 114 proximate to the bottom side 108 of the torso portion 100. The bottom edge 114 of the torso portion 100 defines an opening 116 that is configured to receive and encircle a portion of the body (e.g., waist, hips, stomach etc.) of the wearer of the shirt 10. The torso portion 100 includes a base material 117 and a plurality of bands 118, 119, 122, and 124 that span across the base material 117. As illustrated in FIG. 1A, and further detailed below, the first band 118 is disposed on the front side 110 of the torso portion 100, where the first band 118 extends from a point proximate to the second side 104 and the top side 106 (e.g., the coupling of the second arm 140 to the torso portion 100), diagonally across and down the front side 110 of the torso portion 100 to a point proximate to the first side 102 and the bottom side 108 of the torso portion 100. As illustrated in FIG. 1B, the second band 122 and the third band 124 are disposed on the rear side 120 of the torso portion 100. The second band 122 extends from a point proximate to the first side 102 and the top side 106 (e.g., the coupling of the first arm 130 to the torso portion 100), diagonally across and down the rear side 120 of the torso portion 100 to a point proximate to the second side 104 and the bottom side 108 of the torso portion 100. Conversely, the third band 124 extends from a point proximate to the second side 104 and the top side 106 (e.g., the coupling of the second arm 140 to the torso portion 100), diagonally across and down the rear side 120 of the torso portion 100 to a point proximate to the first side 102 and the bottom side 108 of the torso portion 100. Thus, as illustrated in FIG. 1B, the second band 122 crosses over or intersects the third band 124. FIGS. 1A and 1B further illustrate that the fourth band 119 extends around the front side 110, the rear side 120, the first side 102, and the second side 104 of the torso portion 100 proximate to the bottom edge 114 of the torso portion 100. As further detailed below, the bands 118, 119, 122, 124 and the base material 117 may each have a different degree of elasticity and/or a different modulus of elasticity.

FIGS. 1A and 1B also illustrate that the top edge 112 of the torso portion and the proximal ends 132, 142 of the first and second sleeves 130, 140, respectively, are collectively coupled to a collar 150 disposed on the top side 106 of the torso portion 100. The collar 150 defines an opening 152 sized and shaped to receive a head and/or neck of a wearer of the shirt 10. Thus, when the shirt 10 is worn by a user, the collar 150 encircles the neck of the user with the head having been inserted through the opening 152 of the collar 150.

The torso portion 100 and sleeves 130, 140 collectively define a cavity of the shirt 10, where the shirt 10, when worn by a user, covers or encircles the upper body of the user. Thus, the torso portion 100 covers and encircles the torso of the user wearing the shirt 10, while the first sleeve 130 covers and encircles the first (e.g., right) arm of the user wearing the shirt 10 and the second sleeve 140 covers and encircles the second (e.g., left) arm of the user wearing the shirt 10.

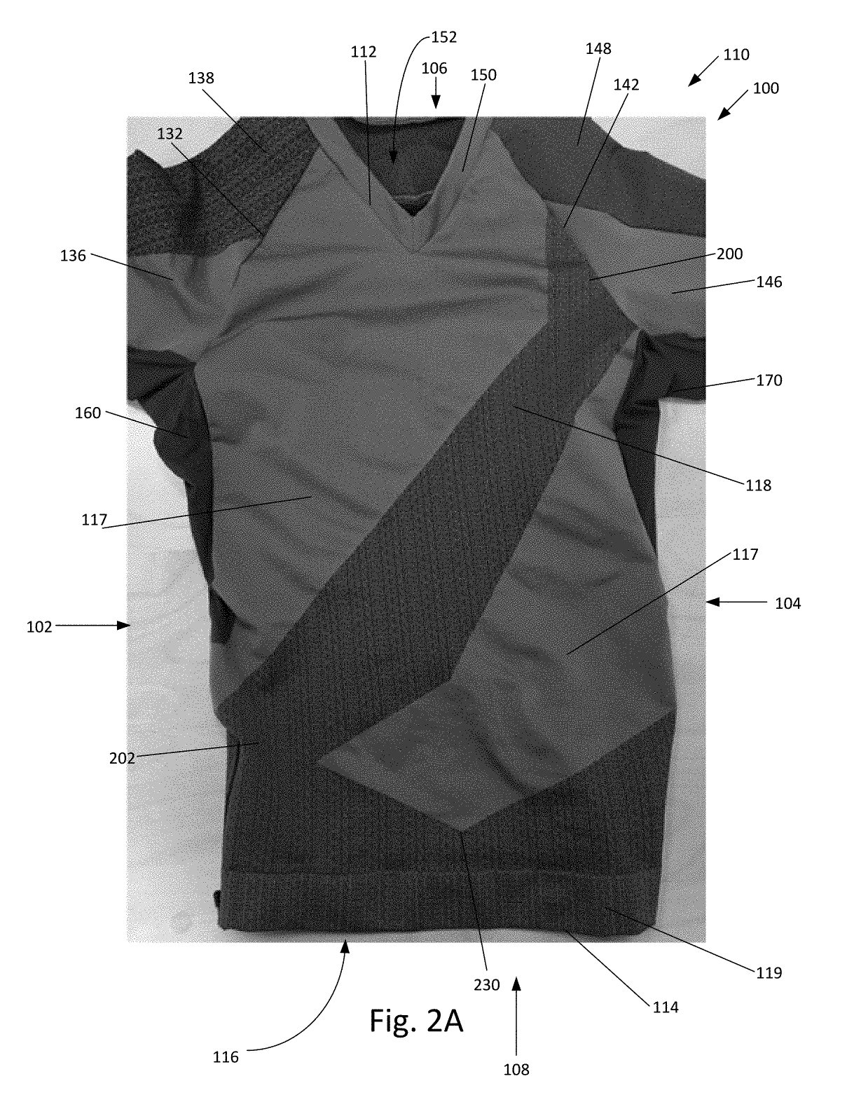

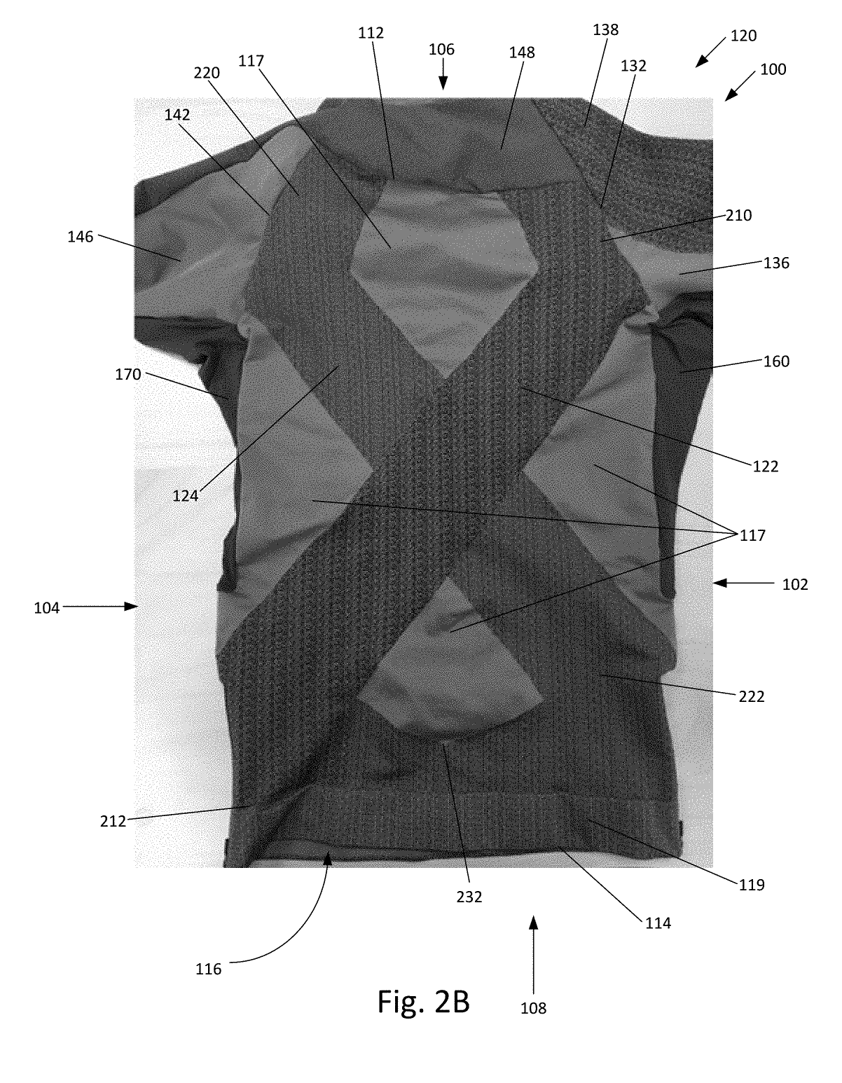

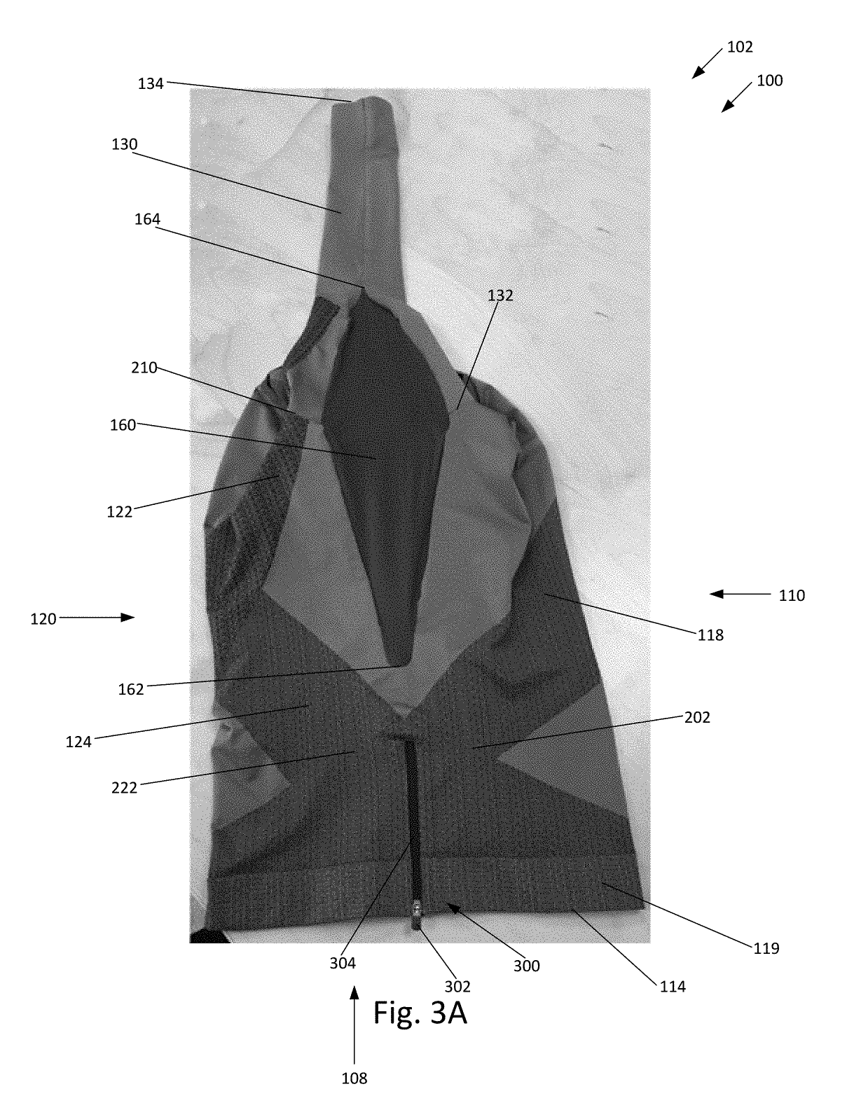

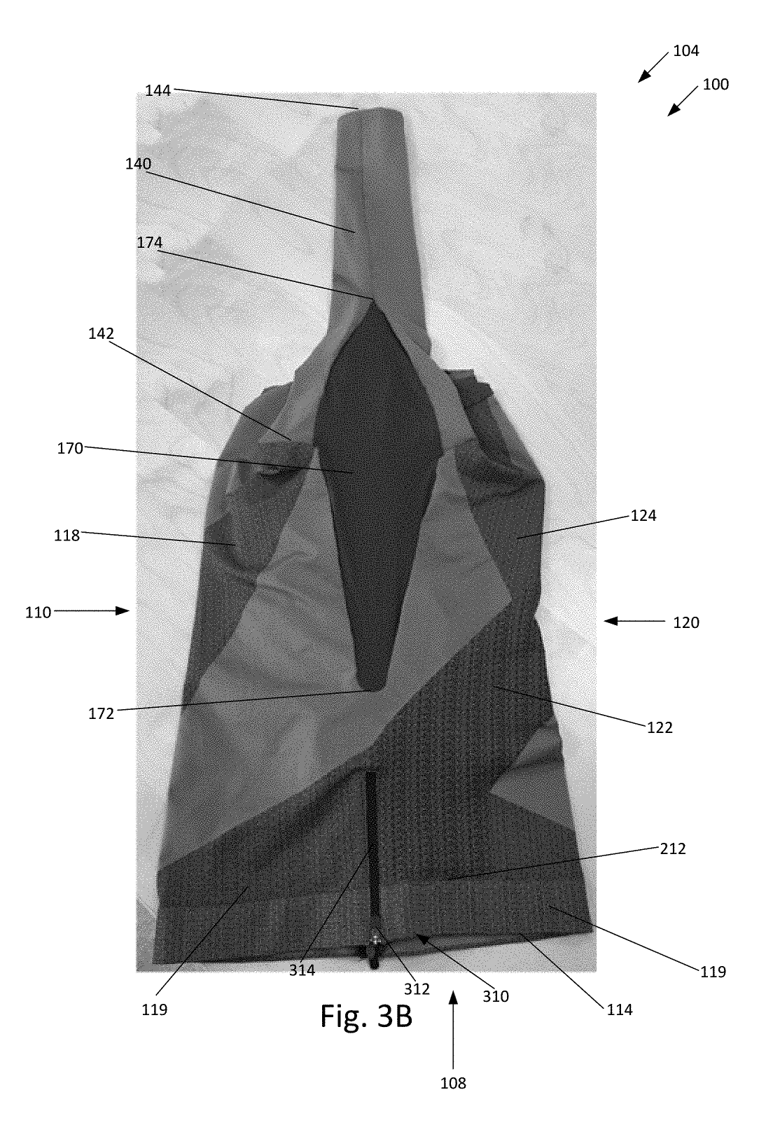

As previously explained, and as best illustrated in FIGS. 2A, 2B, 3A, and 3B, the torso portion 100 includes a first side 102, a second side 104, a top side 106, a bottom side 108, a front side 110, and a rear side 120. The torso portion 100 is a continuous circular panel of knitted fabric with varying amounts of resiliency and moduli of elasticity at different locations. The panel of the torso portion 100 is formed mainly from the base material 117, and includes the first band 118 that disposed on the front side 110 of the torso portion 100, the second band 122 and the third band 124 that are disposed on the rear side 120 of the torso portion 100, and the fourth band 119 that extends around the first, second, front, and rear sides 102, 104, 110, 120 of the torso portion 100 proximate to the bottom edge 114. As best illustrated in FIG. 2A, the first band 118 includes a first end 200 and a second end 202. The first end 200 of the first band 118 is disposed proximate to the top side 104 and the second side 104 of the torso portion 100. Thus, the first end 200 of the first band 118 is disposed proximate to the proximal end 142 of the second sleeve 140. The second end 202 of the first band 118 is disposed proximate to the bottom side 106 and the first side 102 of the torso portion 100, where the second end 202 of the first band 118 is connected with the fourth band 119. Thus, the first band 118 extends diagonally across the front side 110 of the torso portion 100.

As best illustrated in FIG. 2B, the second band 122 includes a first end 210 and a second end 212. The first end 210 of the second band 122 is disposed proximate to the top side 106 and the first side 102 of the torso portion 100. Thus, the first end 210 of the second band 122 is disposed proximate to the proximal end 132 of the first sleeve 130. The second end 212 of the second band 122 is disposed proximate to the bottom side 108 and the second side 104 of the torso portion 100, where the second end 212 of the second band 122 is connected with the fourth band 119. The third band 124 includes a first end 220 and a second end 222. The first end 220 of the third band 124 is disposed proximate to the top side 106 and the second side 104 of the torso portion 100. Thus, the first end 220 of the third band 124 is disposed proximate to the proximal end 142 of the second sleeve 140 and is oriented opposite of the first end 210 of the second band 122 on the rear side 120 of the torso portion 100. The second end 222 of the third band 124 is disposed proximate to the bottom side 108 and the first side 102 of the torso portion 100, where the second end 222 of the third band 124 is also connected with the fourth band 119. The second end 222 of the third band 124 is oriented opposite of the second end 212 of the second band 122 on the rear side 120 of the torso portion 100. As illustrated in FIG. 2B, the second band 122 and the third band 124 both extend diagonally across the rear side 120 of the torso portion 100 such that the second and third bands 122, 124 cross or intersection one another on the rear side 120 of the torso portion 120. More specifically, the second band 122 and the third band 124 form an X-shaped formation on the rear side 120 of the torso portion 100.

The fourth band 119, as previously explained, extends around the front side 110, the first side 102, the rear side 120, and the second side 104 of the torso portion 100 such that the fourth band 119 forms the bottom edge 114 of the torso portion 100. The fourth band 119 includes a first notch 230 centrally disposed on the front side 110 (illustrated in FIG. 2A), and a second notch 232 centrally disposed on the second side 120 (illustrated in FIG. 2B).

The bands 118, 119, 122, 124 collectively form the torso portion 100 with the base material 117. Each of the bands 118, 119, 122, 124 and the base material 117 may be constructed from a knit material with a degree of resiliency and elasticity. For example, the bands 118, 119, 122, 124 and the base material 117 may be constructed from knit materials/fabric with various amounts of elastane fibers/strands. The bands 118, 119, 122, 124 and the base material 117 may be integrally knitted together (i.e., the bands 118, 119, 122, 124 and the base material 117 jointly form an integral structure) to collectively form the continuous panel of the torso portion 100, where the torso portion 100 does not contain seams between the bands 118, 119, 122, 124 and the base material 117.

The first and second sides 102, 104 of the torso portion 100 are best illustrated in FIGS. 3A and 3B. As illustrated, the first side 102 includes a first gusset 160, while the second side 104 includes a second gusset 170. The first gusset 160 is disposed on the first side 102 of the torso portion 100 such that the first gusset 160 extends along the first side 102 of the torso portion 100 and partially along the underside of the first sleeve 130. As illustrated, the first gusset 160 includes a first end 162, which is disposed on the first side 102 of the torso portion 100 at a location between the top edge 112 and the bottom edge 114, and a second end 164, which is disposed on the first sleeve 130 between the proximal end 132 and the distal end 134. The second gusset 170, similar to that of the first gusset 160, is disposed on the second side 104 of the torso portion 100 such that the second gusset 170 extends along the second side 104 of the torso portion 100 and partially along the underside of the second sleeve 140. As illustrated, the second gusset 170 includes a first end 172, which is disposed on the second side 104 of the torso portion 100 at a location between the top edge 112 and the bottom edge 114, and a second end 174, which is disposed on the second sleeve 140 between the proximal end 142 and the distal end 144. Thus, the first and second gussets 160, 170 are located on the shirt 10 such that the gussets 160, 170 align with the arm pits of a user wearing the shirt 10. Similar to the torso portion 100, the gussets 160, 170 are constructed from a knit material/fabric, where the knit material/fabric may be constructed with various amounts of elastane fibers/strands. Thus, the gussets 160, 170 each have a degree of resiliency and a modulus of elasticity. The gussets 160, 170 may be sewn to the torso portion 100 and the sleeves 130, 140 such that a seam is formed between the coupling of the gussets 160, 170 to the torso portion 100 and sleeves 130, 140.

The torso portion 100, as further illustrated in FIGS. 3A, and 3B, also includes a first slit 300 disposed on the first side 102 and a second slit 310 disposed on the second side 104. Both the first and second slits 300, 310 extend substantially upward from the bottom edge 114 of the torso portion 100 through the fourth band 119. As illustrated in FIG. 3A, the first slit 300 extends substantially upwardly from the bottom edge 114 along the first side 102. As illustrated in FIG. 3B, the second slit 310 extends substantially upwardly from the bottom edge 114 along the second side 104.

In the embodiment illustrated in FIG. 3A, the first slit 300 includes a zipper closure 302 and a pair of interlocked teeth tracks 304. The zipper closure 302 is configured to travel upwardly along the pair of interlocked teeth tracks 304 to unlock the pair of teeth tracks 304 from one another and open the slit 300. When the zipper closure 302 travels downwardly along the pair of teeth tracks 304, the pair of teeth tracks 304 become interlocked with one another to close the slit 300. Similarly, in the embodiment illustrated in FIG. 3B, the second slit 310 also includes a zipper closure 312 and a pair of interlocked teeth tracks 314. The zipper closure 312 is configured to travel upwardly along the pair of interlocked teeth tracks 314 to unlock the pair of teeth tracks 314 from one another and open the slit 310. When the zipper closure 312 travels downwardly along the pair of teeth tracks 314, the pair of teeth tracks 314 become interlocked with one another to close the slit 310.

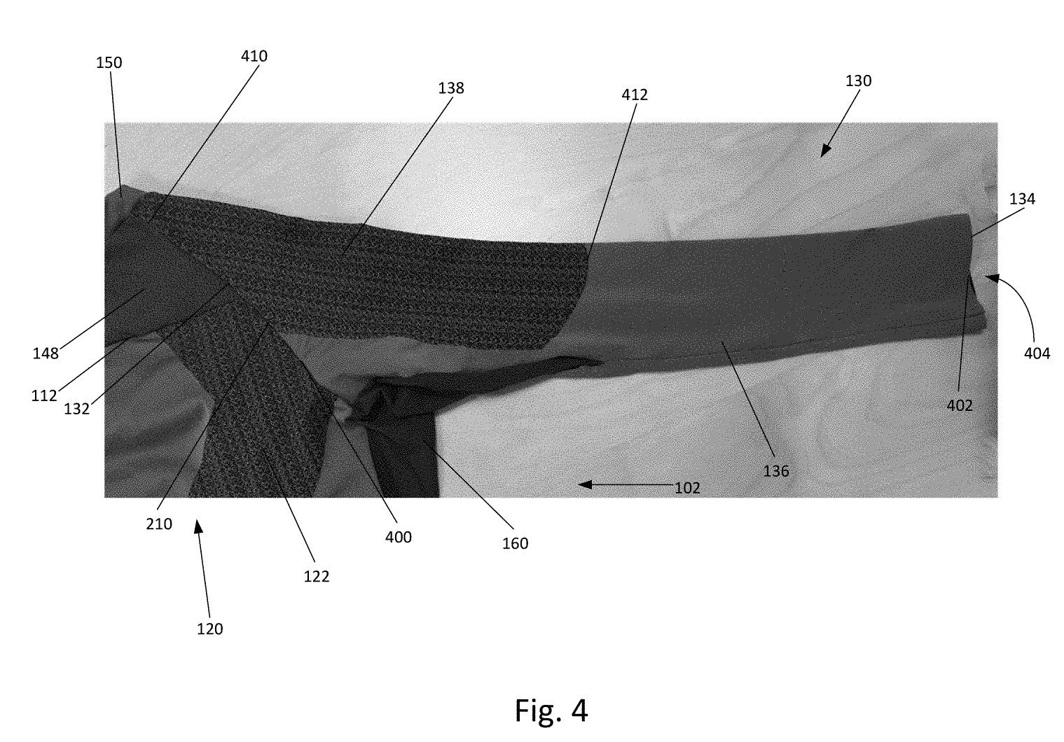

As previously explained, and as further illustrated in FIG. 4, the first sleeve 130 is coupled to and extending from the first side 102 of the torso portion 100, where the proximal end 132 is coupled to the torso portion 100 of the shirt 10, and the distal end 134 is uncoupled from the shirt 10. The first sleeve 130 includes a first or main sleeve portion 136 and a second portion or band 138. The main sleeve portion 136 of the first sleeve 130 forms the majority of the structure of the first sleeve 130, and includes a first end 400 and a second end 402. The first end 400 of the main sleeve portion 136 is aligned with the proximal end 132 of the first sleeve 130. As illustrated in FIGS. 1A, 1B, and 4, the first end 400 of the main sleeve portion 136 is coupled to the top edge 112 of the torso portion 100 (on the front side 110 of the torso portion 100) and to the first end 210 of the second band 122 of the torso portion 100 (on the rear side 120 of the torso portion 100). The second end 402 of the main sleeve portion 136 is aligned with the distal end 134 of the first sleeve 130. Thus, the main sleeve portion 136 extends from the proximal end 132 to the distal end 134 of the first sleeve 130.

The band 138 of the first sleeve 130 includes a first end 410 and a second end 412, and is oriented on the topside of the sleeve 130 such that the band 138 is opposite of the gusset 160. The first end 410 of the band 138 is aligned with the proximal end 132 of the first sleeve 130. Thus, as illustrated in FIGS. 1A, 1B, and 4, the first end 410 of the band 138 is coupled to the top edge 112 of the torso portion 100 (on the front side 110 of the torso portion 100), the first end 210 of the second band 122 of the torso portion 100 (on the rear side 120 of the torso portion 100), the second portion or band 148 of the second sleeve 140 (on the rear side 120 of the torso portion 100), and the collar 150. The second end 412 of the band 138 is disposed along the topside of the first sleeve 130 at a location disposed between the proximal end 132 and the distal end 134 of the first sleeve 130. In the embodiment illustrated, the band 138 of the first sleeve 130 extends approximately halfway down the first sleeve 130 (i.e., the second end 412 of the band 138 is disposed halfway between the proximal end 132 and the distal end 134 of the first sleeve 130).

As illustrated in FIG. 4, because the band 138 and the main sleeve portion 136 are both oriented proximate to the proximal end 132 of the first sleeve 130, the first end 400 of the main sleeve portion 136 and the first end 410 of the band 138 collectively form the proximal end 132 of the first sleeve 130. Conversely, because the band 138 only extends partially along the first sleeve 130 from the proximal end 132 of the first sleeve 130, only the second end 402 of the main sleeve portion 136 forms the distal end 134 of the first sleeve 130. As further illustrated in FIG. 4, the second end 402 (i.e., the distal end 134 of the first sleeve 130) forms an opening 404. The opening 404 is configured to receive a portion (e.g., hand, wrist, forearm, etc.) of the arm of the user when the user is wearing the shirt 10. For example, when the shirt 10 is worn by a user and the first sleeve 130 is disposed around the first arm of the user, the second end 402 may encircle the wrist of the first arm of the user.

Similar to the torso portion 100, the main sleeve portion 136 and the band 138 may be integrally knitted together to collectively form the first sleeve 130, where the first sleeve 130 does not contain seams between the main sleeve portion 136 and the band 138. In another embodiment, the main sleeve portion 136 and the band 138 may be sewed together, such that seams are present between the main sleeve portion 136 and the band 138. In addition, the main sleeve portion 136 and the band 138 are constructed from a knit material/fabric, where the knit material/fabric may be constructed with various amounts of elastane fibers/strands. Thus, both the main sleeve portion 136 and the band 138 each have a certain degree of elasticity and a certain modulus of elasticity.

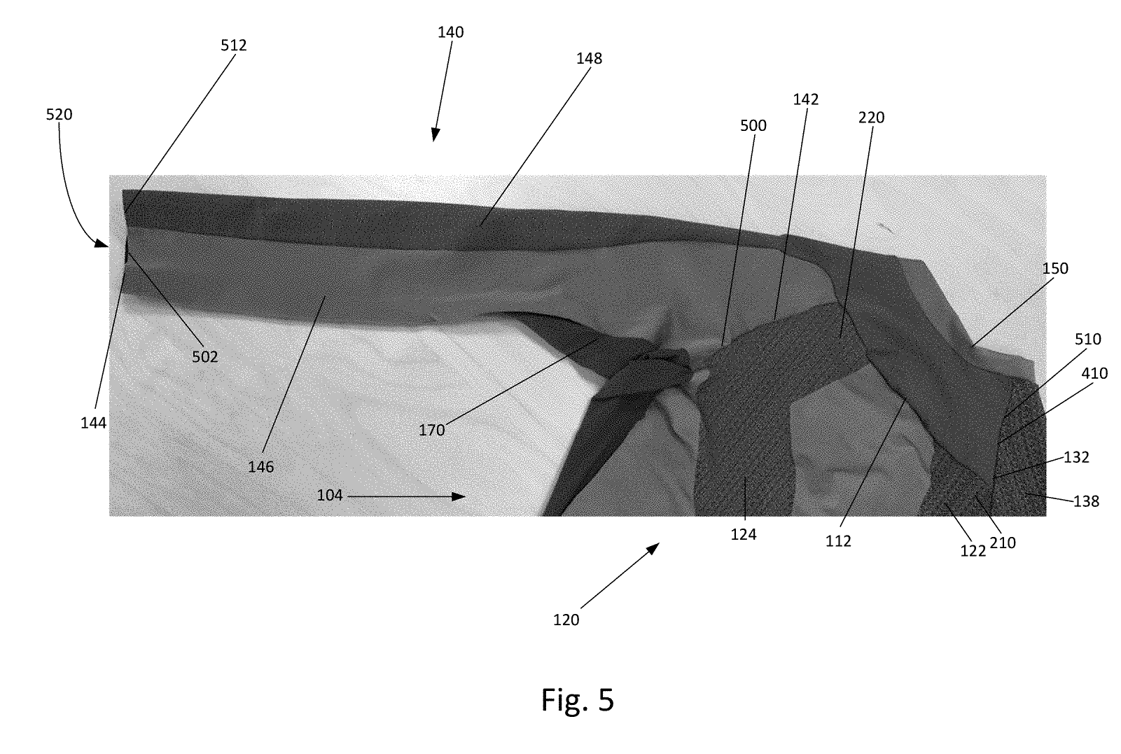

As previously explained, and as further illustrated in FIG. 5, the second sleeve 140 is coupled to, and extends from, the second side 104 of the torso portion 100, where the proximal end 142 is coupled to the torso portion 100 of the shirt 10, and the distal end 144 is uncoupled from the shirt 10. The second sleeve 140 includes a first or main sleeve portion 146 and a second portion or band 148. As best illustrated in FIG. 5, the main sleeve portion 146 of the second sleeve 140 forms the lower portion of the second sleeve 140, and includes a first end 500 and a second end 502. The first end 500 of the main sleeve portion 146 of the second sleeve 140 is aligned with the proximal end 142 of the second sleeve 140. As illustrated in FIGS. 1A, 1B, and 5, the first end 500 of the main sleeve portion 146 is coupled to the top edge 112 of the torso portion 100, the first end 200 of the first band 118 (on the front side 110 of the torso portion 100), and the first end 220 of the third band 124 (on the rear side 120 of the torso portion 100). The second end 502 of the main sleeve portion 146 is aligned with the distal end 144 of the second sleeve 140.

The band 148 of the second sleeve 140 also includes a first end 510 and a second end 512. As illustrated in FIG. 5, while the second end 512 of the band 148 is aligned with the distal end 144 of the second sleeve 140, the band 148 extends beyond the proximal end 142 of the second sleeve 140 such that the first end 510 of the band 148 is coupled to the proximal end 132 of the first sleeve 130 on the rear side 100 of the torso portion 100. In other words, the band 148 extends along the length of the second sleeve 140 and around the rear side 120 of the torso portion 100 such that the first end 510 of the band 148 of the second sleeve 140 is coupled to the proximal end 132 of the first sleeve 130, and more specifically, the first end 410 of the band 138 of the first sleeve 130. The first end 510 of the band 148 of the second sleeve 140 is also disposed proximate to the first end 210 of the second band 122 disposed on the rear side 120 of the torso portion 100. When the shirt 10 is worn by a user, the band 148 is configured to extend up the second arm of the user and around the back of the shoulders and neck of the user.

Because both the second end 502 of the main sleeve portion 146 and the second end 512 of the band 148 are aligned with the distal end 144 of the second sleeve 140, the second end 502 of the main sleeve portion 146 and the second end 512 of the band 148 collectively form the distal end 144 of the second sleeve 140. As further illustrated in FIG. 5, these second ends 502, 512 collectively form an opening 520. The opening 520 is configured to receive a portion (e.g., hand, wrist, forearm, etc.) of the arm of the user when the user is wearing the shirt 10. For example, when the shirt 10 is worn by a user and the second sleeve 140 is disposed around the second arm of the user, the distal end 144 of the second sleeve 140 may encircle the wrist of the second arm of the user.

Similar to the torso portion 100 and the first sleeve 130, the main sleeve portion 146 and the band 148 of the second sleeve 140 may be integrally knitted together to collectively form the second sleeve 140, where the second sleeve 140 does not contain seams between the main sleeve portion 146 and the band 148. In another embodiment, the main sleeve portion 146 and the band 148 of the second sleeve 140 may be sewed together, such that seams are present between the main sleeve portion 146 and the band 148. In addition, the main sleeve portion 146 and the band 148 of the second sleeve 140 are constructed from a knit material/fabric, where the knit material/fabric may be constructed with various amounts of elastane fibers/strands. Thus, the main sleeve portion 146 and the band 148 may each have a certain degree of elasticity and modulus of elasticity.

As previously explained, the bands 118, 119, 122, 124 of the torso portion 100, the base material 117 of the torso portion 100, the portions 136, 146 and the bands 138, 148 of the sleeves 130, 140, and the gussets 160, 170 are each constructed from knitted materials/fabrics. Knitting is a process for constructing fabric by interlooping one or more yarns. In general, knitting includes warp knitting and weft knitting. In warp knitting, the yarns generally run lengthwise in the fabric (e.g., tricot, milanese, and raschel knitting). In weft knitting, one continuous thread runs crosswise in the fabric making all of the loops in one course. Weft knitting includes both circular knitting and flat knitting. In circular knitting, the fabric is produced on the knitting machine in the form of a tube, with the threads running continuously around the fabric. In flat knitting, the fabric is produced on the knitting machine in flat form, the threads alternating back and forth across the fabric. A plaited knit structure can also be formed which includes an interior layer or face and an exterior layer or face formed of the same or varying strands and/or stitches. Both the interior and exterior layers are formed concurrently by knitting a plaited construction so that the layers are distinct, yet integrated one with the other.

The textile formed, e.g., via any suitable process (e.g., knitting and/or weaving, etc.), may comprise any suitable number (e.g., one or more) and/or types of strands. The term strand includes a single fiber, filament, or monofilament, as well as an ordered assemblage of textile fibers having a high ratio of length to diameter and normally used as a unit (e.g., slivers, roving, single yarns, plies yarns, cords, braids, ropes, etc.). In an example embodiment a strand is a yarn (a continuous strand of textile fibers, filaments, or material in a form suitable for knitting, weaving, or otherwise intertwining to form a textile fabric). A yarn may include a number of fibers twisted together (spun yarn); a number of filaments laid together without twist (a zero-twist yarn); a number of filaments laid together with a degree of twist; and a single filament with or without twist (a monofilament).

In general, the strands forming the textiles of the torso portion 100, first sleeve 130, second sleeve 140, and gussets 160, 170 can be natural strands (e.g., cotton strands, wool strands, silk strands, etc.) and/or synthetic strands formed of one or more types of polymers, including fibers or filaments having one or more polymer components formed within the fibers or filaments. Some non-limiting examples of materials that may be utilized in the spun staple and/or continuous filament hard yarns include cotton, polyester (e.g., polyethylene terephthalate, polybutylene terephthalate, etc.), polyamides (e.g., nylon), polyolefins (e.g., polypropylene, polyethylene, etc.), acrylics, wool, acetate, polyacrylonitrile and/or any combinations thereof. Natural fibers can include, e.g., cellulosic fibers (e.g., cotton, bamboo) or protein fibers (e.g., wool, silk, and soybean).

The strands may further be elastic or non-elastic strands. An elastic strand possesses elasticity and/or recovery, i.e., the ability to recover its original size and shape immediately after removal of a stress (i.e., after stretching) causing deformation (the degree to which fibers, yarn, or cord returns to its original size and shape after deformation indicates how well a fabric recovers). An elastic strand, by virtue of its composition, possesses the ability to stretch. Some specific examples of elastic polymer components suitable for forming an elastic strand are, without limitation, elastomeric polyester-polyurethane copolymers such as elastane, which is a manufactured fiber in which the fiber-forming substance is a long chain synthetic polymer composed of at least 85% of segmented polyurethane.

Non-elastic strands possess little to no elasticity. Strands formed of hard fibers and strands formed of high tensile strength filaments are examples of non-elastic strands. Hard yarns are yarns that are substantially non-elastic. That is, hard yarns include knitting yarns which possess little to no elastic stretch, such as natural and/or synthetic spun staple yarns, natural and/or synthetic continuous filament yarns, and combinations thereof. Examples of materials that may be utilized in the spun staple and/or continuous filament hard yarns include cotton, polyester, nylon, polypropylene, polyethylene, acrylics, wool, acetate, polyacryonitrile, and combinations thereof. Natural fibers include cellulosic fibers (e.g., cotton, bamboo) or protein fibers (e.g., wool, silk, and soybean). They also can be of mono component poly(ethylene terephthalate) and poly(trimethylene terephthalate) fiber, polycaprolactam fiber, poly(hexamethylene adipamide) fibers acrylic fibers, modacrylic, acetate fibers, rayon fibers, nylon and combinations thereof.

It should be understood that while non-elastic yarns do not possess elasticity, they may be made resilient via texturing. For example, crimping a polyester filament permits the filament to expand from its normal position to an expanded position upon application of force. Upon removal of the force, the filament returns to its normal position.

Additionally, the strand may be high tensile strength strands, i.e., strands possessing high tensile strength. Examples of high-tensile-strength strands are rayon, nylon, polyester, polyacrylic, silk, cotton, carbon, glass, aramids (e.g., para-aramid fibers and meta-aramid fibers), ultra-high molecular weight polyethylene, and liquid crystal polymer. In an example embodiment, the high tensile strength strand is an ultrahigh molecular weight polyolefins such as ultrahigh molecular weight polyethylene (UHMW-PE) having a molecular weight of at least about 2 million Dalton (Da) (e.g., a molecular weight from about 2 million Da to about 6 million Da).

The various types of strands that can be used to form textile structures (i.e., torso portion 100, bands 118, 119, 122, 124, base material 117, sleeves 130, 140, main sleeve portions 136, 146, bands 138, 148, gussets 160, 170) of the shirt 10 may impart varying properties into the textile structure that form the different portions of the shirt 10. This results in the shirt 10 inheriting the properties of the textile structures that form the shirt 10, where the properties are located at the portions of the shirt 10 that formed from their representative textile structure. As described in further detail herein, textile structures or portions of the shirt 10 can be formed in which the degree of stretch or degree of elasticity of one textile structure or portion of the shirt 10 differs (e.g., are greater or less than) from the degree of stretch or degree of elasticity of another textile structure or portion of the shirt 10. Further, the modulus of elasticity can also change for different textile structures/portions of the shirt (e.g., for the different bands).

As previously described, each of the bands 118, 119, 122, 124 of the torso portion 100, the base material 117 of the torso portion 100, the portions 136, 146 and the bands 138, 148 of the sleeves 130, 140, and the gussets 160, 170 may be constructed from a knit material/fabric that includes strands or yarns of an elastic material such as elastane. Thus, each of the bands 118, 119, 122, 124 of the torso portion 100, the base material 117 of the torso portion 100, the portions 136, 146 and the bands 138, 148 of the sleeves 130, 140, and the gussets 160, 170 may have different moduli of elasticity. In the embodiment of the shirt 10 illustrated in FIGS. 1A, 1B, 2A, 2B, 3A, 3B, 4 and 5, the gussets 160, 170 have a first modulus of elasticity. The gussets 160, 170 may also be constructed of a thinner more air permeable material, enabling air to flow through the gussets 160, 170 (e.g., to release hot air trapped within the interior of the shirt 10, enable cool air to travel into the interior of the shirt 10, etc.) to cool the person wearing the shirt 10. The base material 117 of the torso portion 100 and the main sleeve portions 136, 146 of the sleeves 130, 140 have a second modulus of elasticity, where the second modulus of elasticity is greater than the first modulus of elasticity of the gussets 160, 170. The band 148 of the second sleeve 140 is constructed with a third modulus of elasticity, which is greater than both the first and second moduli of elasticity. In addition, the first, third, and fourth bands 118, 124, 119 of the torso portion 100 are constructed with a fourth modulus of elasticity. The fourth modulus of elasticity of the first, third, and fourth bands 118, 124, 119 of the torso portion 100 is greater than the first, second, and third moduli of elasticity. Finally, the third band 122 of the torso portion 100 and the band 138 of the first sleeve 130 are constructed to have a fifth modulus of elasticity, which is greater than any of the moduli of elasticity of the other portions of the shirt 10. Thus, the third band 122 of the torso portion 100 and the band 138 of the first sleeve 130 impose the greatest amount of resilient force onto the person wearing the shirt 10 (e.g., the greatest resistance to stretching), while the gussets 160, 170, and the base material 117 of the torso portion 100 and the main sleeve portions 136, 146 of the sleeves 130, 140 impose the least amount of resilient force (e.g., least resistance to stretching) onto the person wearing the shirt 10.

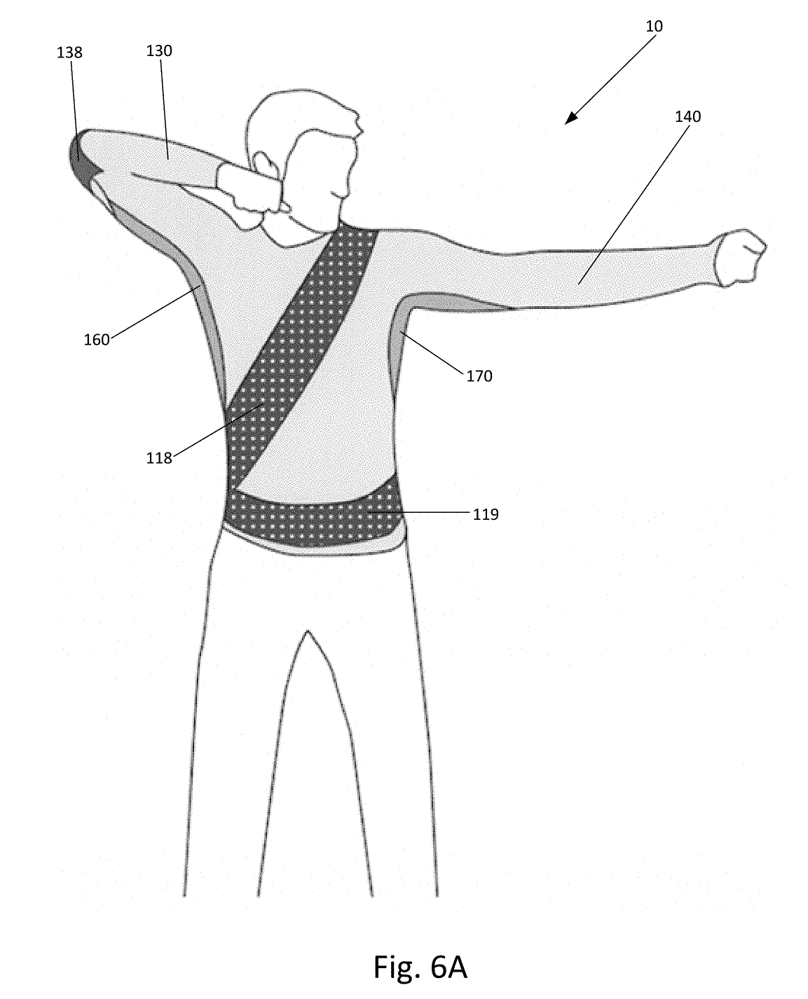

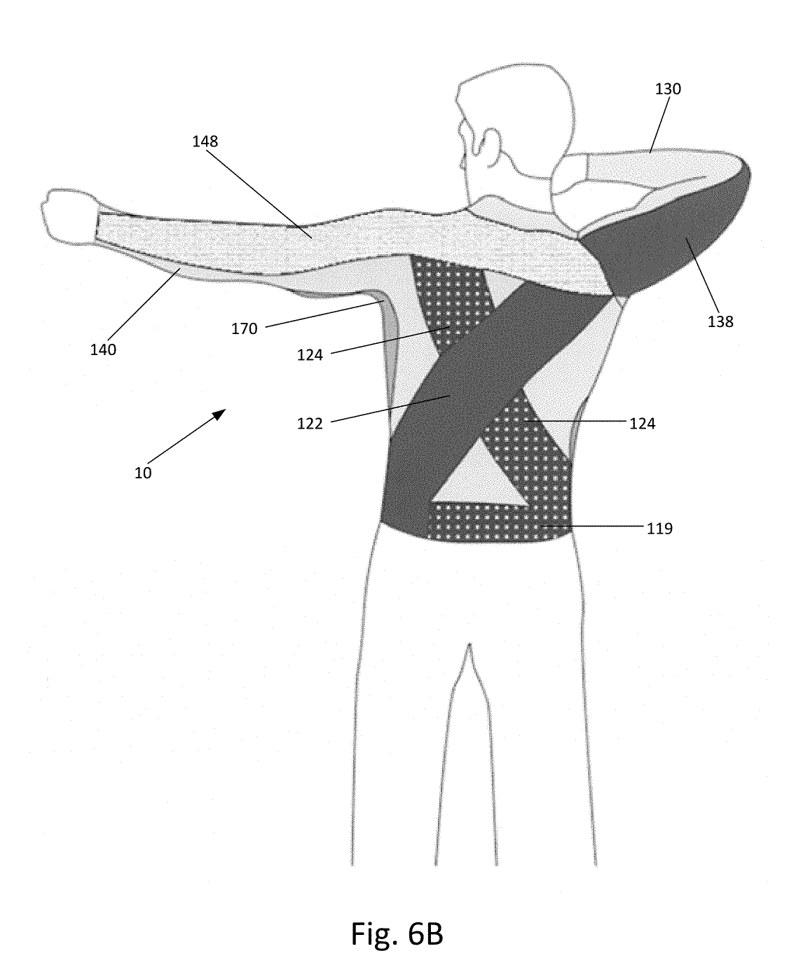

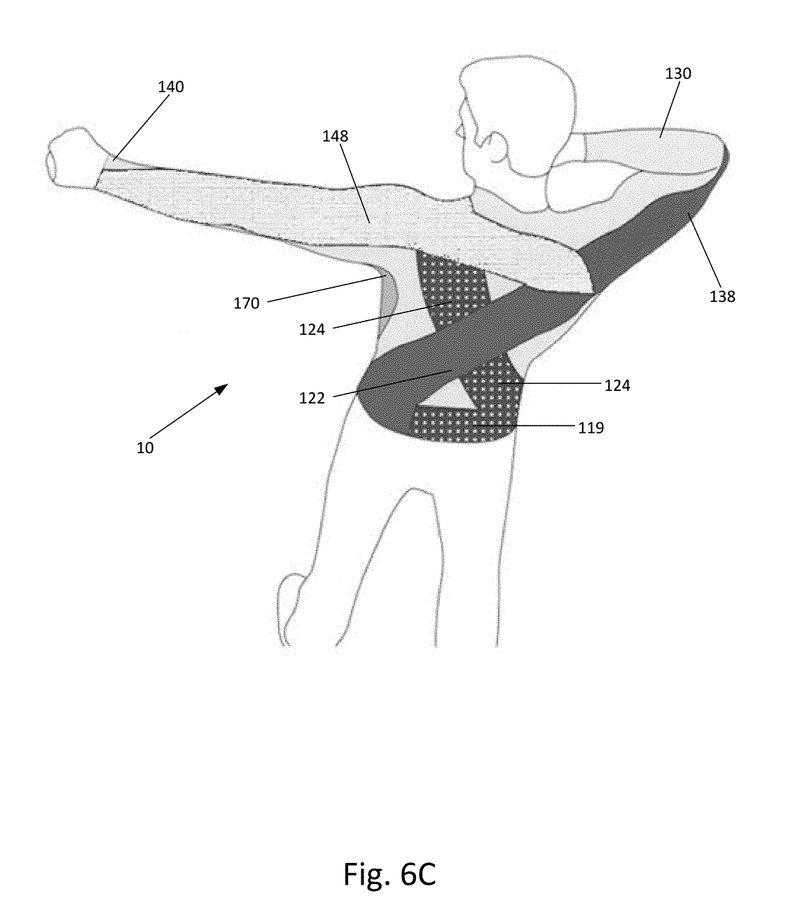

The varying moduli of elasticity of each of the bands 118, 119, 122, 124, 138, 148, coupled with the specific locations and coverage of each of the bands 118, 119, 122, 124, 138, 148 empowers the shirt 10 to provide targeted support to specific muscles of a user wearing the shirt 10 when performing specific actions or activities (e.g., archery, shooting, etc.). The user illustrated in FIGS. 6A, 6B, and 6C is depicted in a proper archery shooting pose, the bow and arrow being removed for illustrative purposes. As illustrated, the first band 118 of the torso portion 100 extends diagonally across the chest of the user, while the second and third bands 122, 124 of the torso portion 100 are oriented in a crisscross X-shaped pattern across the back of the user. In addition, the fourth band 119 of the torso portion 100 is disposed around the waist of the user wearing the shirt 10.

As further illustrated, the user's left arm is in a raised and extended position, while the user's right arm is in a raised and completely bent position. If the user were holding a bow, the handle/riser of the bow would be held in the user's left hand and extended away from the user's body by the raised and extended left arm, while the bow string and/or arrow would be pulled back from the handle/riser of the bow by the right arm until the right arm is positioned in the raised and bent position illustrated. As best illustrated in FIGS. 6B and 6C, the band 138 of the first sleeve 130 extends along the upper arm to approximately the elbow of the user, where the band 138 is aligned with shoulder and triceps brachii muscle of the user's right arm. The band 148 of the second sleeve 140 extends from the band 138 of the first sleeve 138, across the rear side of the user's shoulders, and down the backside of the user's left arm.

The resiliency of the band 138 of the first sleeve 130 imparts a force onto the right arm of the user wearing the shirt 10 to place, guide, or draw the right arm into the position (raised and completely bent) illustrated in FIGS. 6A, 6B, 6C. As previously explained, the band 138 of the first sleeve 130 extends approximately halfway down the first sleeve 130, where the positioning and the modulus of elasticity of the band 138 of the first sleeve 130 draws the right arm into the raised and bent position illustrated. If the band 138 were to extended a further distance along the first sleeve 130, the right arm of the user wearing the shirt 10 would no longer be drawn into the desired position shown (i.e., the right arm of the user may be drawn down and rearward). In addition, the positioning and the modulus of elasticity of the band 148 of the second sleeve 140 imparts a force onto the left arm of the user wearing the shirt 10 to place, guide, or draw the left arm into the position (raised and extended) illustrated in FIGS. 6A, 6B, and 6C. The positioning and the moduli of elasticity of the bands 118, 122, 124 of the torso portion impart forces onto the torso of the user, as well as secondary forces onto the arms of the user. The bands 118, 122, 124 position the torso of the user into the proper position (i.e., back straight, chest out, shoulders back, etc.), while also imparting secondary forces onto the shoulders and arms to aid in drawing the arms into the positions illustrated in FIGS. 6A, 6B, and 6C. Finally, because the fourth band 119 of the torso portion 100 encircles the waist of the user wearing the shirt 10, and because of the modulus of elasticity of the fourth band 119, the fourth band 119 imparts a compression force onto the waist of the user to anchor the shirt 10 (i.e., prevent the shirt 10 from riding up the torso of the user when the user raises their arms).

Additionally, the modulus of elasticity of the base material 117 of the torso portion 100 and the main sleeve portions 136, 146 of the sleeves 130, 140, respectively, create a tight form fitting garment. Thus, the modulus of elasticity of the base material 117 of the torso portion 100 and the main sleeve portions 136, 146 of the sleeves 130, 140 may not be of a value that causes the muscles of the user to position their body in specific positions or orientations, but may be of a value that causes the shirt 10 to sit closely against the body of the user wearing the shirt and create a compression fit.

As previously explained, the shirt or garment 10 includes a plurality of bands 118, 119, 122, 124 138, 148 with varying moduli of elasticity. The embodiment of the shirt 10 illustrated in FIGS. 1A, 1B, 2A, 2B, 3A, 3B, 4, 5, 6A, 6B, and 6C is designed to aid the user in placing their upper body (i.e., torso, shoulders, arms, etc.) in the proper form/proper positioning for archery shooting. In addition, the bands 118, 119, 122, 124 138, 148, as described herein, reduce muscle fatigue of the muscles of the upper body of the user and/or enhance proper user form (e.g., proper positioning and alignment of user's limbs) during an archery shooting event because the bands 118, 119, 122, 124 138, 148 serve to support various portions of the upper body (i.e., arms, shoulders, torso, etc.) when oriented in the proper archery shooting position. Often, the user is required to hold an archery shooting position, that as shown in FIGS. 6A, 6B, and 6C, for a prolonged period of time (i.e., when waiting for a target to move into position). By supporting the various portions of the upper body, the bands 118, 119, 122, 124 138, 148 reduce the strain on the muscles of the upper body, enabling a user to hold the shooting position for a longer amount of time and reducing the amount of energy consumed by the muscles to hold the shooting position.

Additionally, the embodiment of the shirt 10 illustrated in FIGS. 1A, 1B, 2A, 2B, 3A, 3B, 4, 5, 6A, 6B, and 6C may be used as a training shirt. Because the bands 118, 119, 122, 124 138, 148 impart forces onto the various portions of the upper body to draw or place the arms and the torso of the upper body of the user wearing the shirt 10 into the proper archery shooting position, the user wearing the shirt 10 may experience various pulling and pushing forces from the shirt 10. However, when the user orients or places their upper body into the proper shooting position, these pulling and pushing forces may be minimized or eliminated. Thus, the shirt 10 may be utilized to teach muscle memory of the proper form/proper positioning of the various body parts, where the user wearing the shirt 10 will know they have placed their body in the proper shooting form when they no longer feel forces imparted onto their body by the shirt 10.

Other embodiments of the shirt 10 may include any number of bands disposed on the shirt 10 (i.e., the number of bands being greater or fewer than that illustrated in FIGS. 1A, 1B, 2A, 2B, 3A, 3B, 4, 5, 6A, 6B, 6C). The position and orientation of the bands on the shirt 10 may be adjusted to alter the effect the shirt 10 has in placing portions of the body in specific positions. In addition, the moduli of elasticity of the bands of the shirt 10 may also be adjusted to alter the effect the shirt 10 has in placing portions of the body in specific positions. Altering or adjusting the positioning, orientation, and moduli of elasticity of the bands of the shirt 10 enables the shirt 10 to be manufactured or constructed to enhance specific muscle proprioception while reducing muscle oscillation (i.e., reducing muscle fatigue). In other words, altering or adjusting the positioning, orientation, and moduli of elasticity of the bands of the shirt 10 changes the magnitude and direction of the forces imparted by the shirt 10 onto the user wearing the shirt 10. Thus, a garment may be constructed with resilient bands in specifically designed areas, in specific orientations, and with varying moduli of elasticities to guide the muscles and appendages of a user wearing the garment to enhance the performance of specific activities (e.g., shooting, throwing an object, running, lifting weights, etc.).

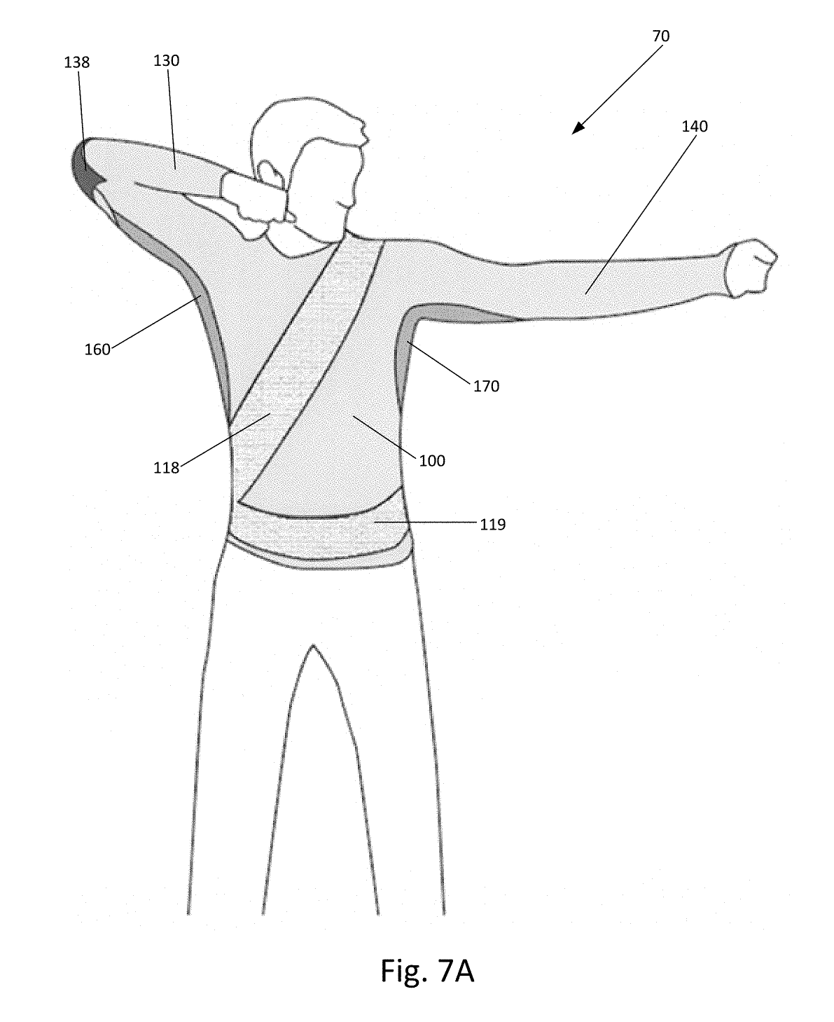

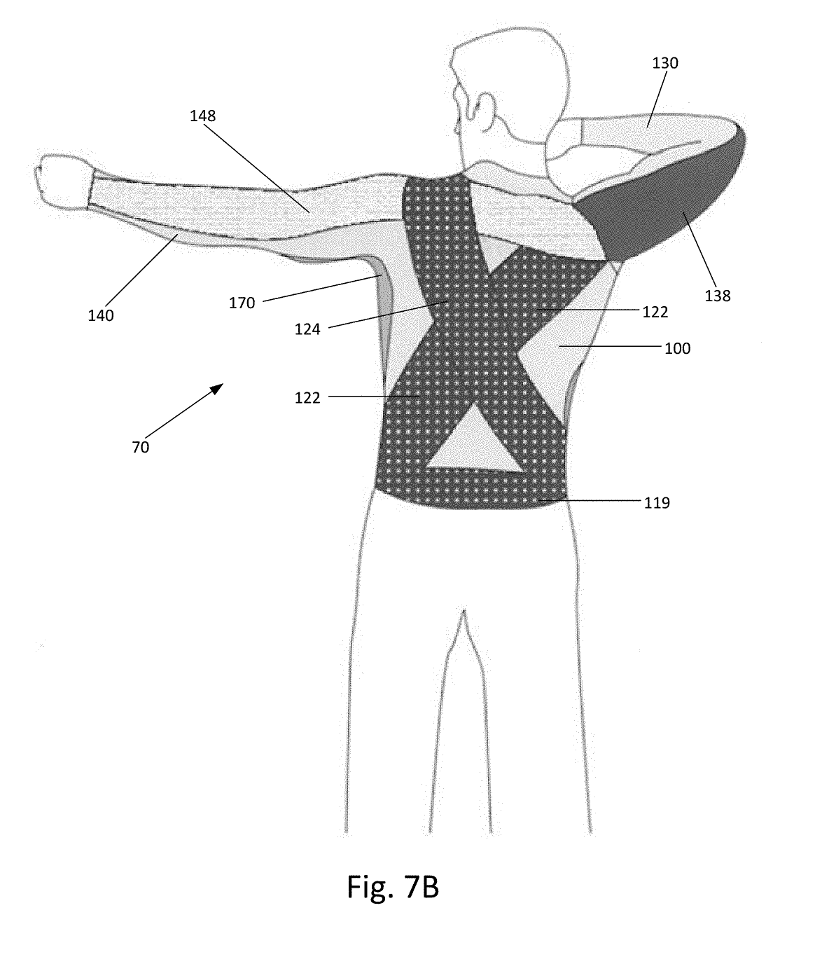

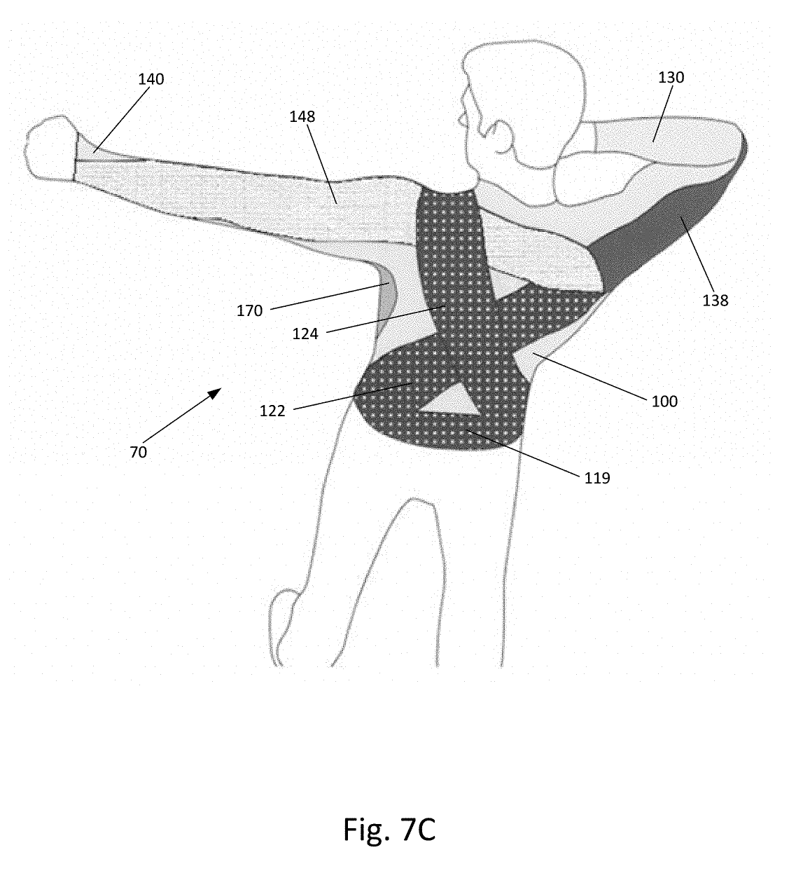

In another embodiment of the shirt 70 (illustrated in FIGS. 7A, 7B, and 7C), the bands 118, 119, 122, 124 138, 148 may be constructed with different moduli of elasticity than that of the shirt 10 illustrated in FIGS. 1A, 1B, 2A, 2B, 3A, 3B, 4, 5, 6A, 6B, 6C. Similar to the first embodiment of the shirt 10, the second embodiment of the shirt 70 includes a first band 118 disposed diagonally across the front side of the torso portion 100 of the shirt 70, second and third bands 122, 124 disposed diagonally and intersecting one another on the rear side of the torso portion 100 of the shirt 70, and a fourth band 119 disposed around the bottom edge of the torso portion 100 of the shirt 70. Also similar to the first embodiment of the shirt 10, the second embodiment of the shirt 70 includes a band 138 partially disposed along the first sleeve 130 of the shirt 70, and a band 148 disposed along the entire length of the second sleeve 140 of the shirt 70 and across the top of the rear side of the torso portion 100. The moduli of elasticity of the bands 118, 119, 122, 124 138, 148 of the second embodiment of the shirt 70, however, differ from that of the bands 118, 119, 122, 124 138, 148 of the first embodiment of the shirt 10.

As illustrated in FIGS. 7A, 7B, and 7C, the first band 118, the band 148 on the second sleeve 140, and the front half of the fourth band 119 (e.g., the portion of the fourth band 119 disposed on the front side of the torso portion 100) each contain the same modulus of elasticity. In addition, the second and third bands 122, 124 on disposed on the rear side of the torso portion 100 and the rear half of the fourth band 119 (e.g., the portion on the rear side of the torso portion 100) each contain the same modulus of elasticity. Finally, the band 138 disposed along the first sleeve 130 does not contain the same modulus of elasticity as any other band disposed on the second embodiment of the shirt 70.

As illustrated in FIGS. 7A, 7B, and 7C, the band 138 disposed along the first sleeve 130 has a first modulus of elasticity, while the second and third bands 122, 124 disposed on the rear side of the torso portion 100 and the rear half of the fourth band 119 (e.g., the portion on the rear side of the torso portion 100) have a second modulus of elasticity that differs from the first modulus of elasticity. The first modulus of elasticity is greater in value than that of the second modulus of elasticity (i.e., the band 138 of the first sleeve 130 has a greater resistance to stretching than that of the second and third bands 122, 124 and the rear half of the fourth band 119). In addition, the first band 118, the band 148 on the second sleeve 140, and the front half of the fourth band 119 (e.g., the portion of the fourth band 119 disposed on the front side of the torso portion 100) have a third modulus of elasticity. The first and second moduli of elasticity are both greater in value than the third modulus of elasticity (i.e., bands 118, 148 and the front half of the fourth band 119 have the least resistance to stretching of the bands 118, 119, 122, 124 138, 148 of the second embodiment of the shirt 70). While the modulus of elasticity of the bands 118, 119, 122, 124 138, 148 of the second embodiment of the shirt 70 may differ from the bands 118, 119, 122, 124 138, 148 of the first embodiment of the shirt 10, the second embodiment of the shirt 70 may still perform the same or similar function as the first embodiment of the shirt 10.

While the invention has been described in detail and with reference to specific embodiments thereof, it will be apparent to one skilled in the art that various changes and modifications can be made therein without departing from the spirit and scope thereof.

Thus, it is intended that the present invention covers the modifications and variations of this invention provided they come within the scope of the appended claims and their equivalents. It is to be understood that terms such as “top”, “bottom”, “front”, “rear”, “side”, “height”, “length”, “width”, “upper”, “lower”, “interior”, “exterior”, and the like as may be used herein, merely describe points of reference and do not limit the present invention to any particular orientation or configuration.

Although the disclosed inventions are illustrated and described herein as embodied in one or more specific examples, it is nevertheless not intended to be limited to the details shown, since various modifications and structural changes may be made therein without departing from the scope of the inventions and within the scope and range of equivalents of the claims. In addition, various features from one of the embodiments may be incorporated into another of the embodiments. Accordingly, it is appropriate that the appended claims be construed broadly and in a manner consistent with the scope of the disclosure as set forth in the following claims.

What is claimed is:

1. An article of clothing comprising:
a torso portion having a front side, a rear side, a first side, and a second side, the torso further comprising a first resilient band;
a first sleeve coupled to the first side of the torso portion, the first sleeve including a second resilient band; and
a second sleeve coupled to the second side of the torso portion, the second sleeve including a third resilient band, wherein the first resilient band has a first modulus of elasticity, the second resilient band has a second modulus of elasticity, and the third band has a third modulus of elasticity.

2. The article of clothing of claim 1, wherein the first resilient band is disposed diagonally on the front side of the torso portion.

3. The article of clothing of claim 2, wherein the torso portion further comprises:
a fourth resilient band disposed diagonally on the rear side of the torso portion in a first orientation; and
a fifth resilient band disposed diagonally on the rear side of the torso portion in a second orientation, the fifth resilient band intersecting the fourth resilient band,
wherein the fourth resilient band has the first modulus of elasticity, and the fifth resilient band has the third modulus of elasticity.

4. The article of clothing of claim 3, wherein the first, fourth, and fifth resilient bands are configured to provide support to a torso of a user of the article of clothing.

5. The article of clothing of claim 3, wherein the torso portion further comprises:
a top edge;
a bottom edge; and
a sixth resilient band disposed along the bottom edge on the front side, the rear side, the first side, and the second side, the sixth resilient band having the first modulus of elasticity.

6. The article of clothing of claim 5, wherein the sixth resilient band is configured to anchor the bottom edge of the article of clothing to a waist of a user.

7. The article of clothing of claim 5, wherein the second sleeve has a proximal end and a distal end, the proximal end of the second sleeve being coupled to the second side of the torso portion proximate the top edge of the torso portion.

8. The article of clothing of claim 7, wherein the third resilient band extends along the second sleeve from the distal end of the second sleeve, past the proximal end of the second sleeve, and around the rear side of the torso portion along the top edge of the torso portion.

9. The article of clothing of claim 8, wherein the third resilient band is configured to position an arm of a user wearing the article of clothing in a raised and extended position.

10. The article of clothing of claim 5, wherein the first sleeve has a proximal end and a distal end, the proximal end of the first sleeve being coupled to the first side of the torso portion proximate the top edge of the torso portion.

11. The article of clothing of claim 10, wherein the second resilient band has a first end and a second end, the first end being aligned with the proximal end of the first sleeve and the second end being disposed along the first sleeve at a location between the distal end and the proximal end of the first sleeve.

12. The article of clothing of claim 11, wherein the second resilient band is configured to position an arm of a user in a raised and bent position.

13. The article of clothing of claim 1, wherein the torso portion, the first sleeve, the second sleeve, the first resilient band, the second resilient band, and the third resilient band are constructed from a knitted material that includes elastane.

14. An article of clothing comprising:
a torso portion having a front side, a rear side, a top side, a bottom side, a first side, and second side;
a first sleeve having a distal end and a proximal end, the first sleeve coupled to the first side of the torso portion at the proximal end of the first sleeve;
a second sleeve having a distal end and a proximal end, the second sleeve coupled to the second side of the torso portion at the proximal end of the second sleeve;
a first resilient band having a first end, a second end, and a first modulus elasticity, the first resilient band extending along the first sleeve with the first end of the first resilient band disposed adjacent to the proximal end of the first sleeve and the second end of the first resilient band disposed at a position along the first sleeve between the proximal end of the first sleeve and the distal end of the first sleeve;
a second resilient band having a first end, a second end, and a second modulus of elasticity, the second resilient band extending across the rear side of the torso along the top side and along the second sleeve with the first end of the second resilient band disposed adjacent to the proximal end of the first sleeve, and the second end of the second resilient band being disposed adjacent the distal end of the second sleeve;
a third resilient band having a first end, a second end, and a third modulus of elasticity, the third resilient band extending across the front side of the torso portion with the first end of the third resilient band disposed proximate to the top side and the second side of the torso portion and the second end of the third resilient band disposed proximate to the bottom side and the first side of the torso portion;
a fourth resilient band having a first end, a second end, and the third modulus of elasticity, the fourth resilient band extending across the rear side of the torso portion with the first end of the fourth resilient band disposed proximate to the top side and the second side of the torso portion and the second end of the fourth resilient band disposed proximate to the bottom side and the first side of the torso portion;
a fifth resilient band having a first end, a second end, and the first modulus of elasticity, the fifth resilient band extending across the rear side of the torso portion and intersecting the fourth resilient band with the first end of the fifth resilient band disposed proximate to the top side and the first side of the torso portion and the second end of the fifth resilient band disposed proximate to the bottom side and the second side of the torso portion; and
a sixth resilient band extending through the front side, rear side, first side, and second side of the torso portion proximate to the bottom side of the torso portion, the sixth resilient band having the third modulus of elasticity, wherein the first modulus of elasticity is greater than the second modulus of elasticity and the third modulus of elasticity, and the third modulus of elasticity is greater than the second modulus of elasticity.

15. The article of clothing of claim 14, wherein, when a user wears the article of clothing and a first arm of the user is disposed within the first sleeve, the first resilient band is configured to position the first arm of the user in a raised and bent position.

16. The article of clothing of claim 14, wherein, when a user wears the article of clothing and a second arm of the user is disposed within the second sleeve, the second resilient band is configured to position the second arm of the user in a raised and extended position.

17. The article of clothing of claim 14, wherein the third, fourth, and fifth resilient bands are configured to provide support to a torso of a user of the article of clothing.

18. An article of clothing comprising:
a torso portion having a first side and an opposite second side, the torso being constructed from a base material and a first resilient band;
a first sleeve coupled to the first side of the torso portion, the first sleeve being constructed from the base material and a second resilient band; and
a second sleeve coupled to the second side of the torso portion, the second sleeve being constructed from the base material and a third resilient band, wherein the first resilient band is integrally knitted with the base material of the torso, the second resilient band is integrally knitted with the base material of the first sleeve, and the third resilient band is integrally knitted with the base material of the second sleeve.

19. The article of clothing of claim 18, wherein the base material has a first modulus of elasticity, the first resilient band has a second modulus of elasticity, the second resilient band has a third modulus of elasticity, and the third band has a fourth modulus of elasticity,
wherein the third modulus of elasticity is greater than the first, second, and fourth moduli of elasticity, the second modulus of elasticity is greater than the first and fourth moduli of elasticity, and the fourth modulus of elasticity is greater than the first modulus of elasticity.

20. The article of clothing of claim 19, wherein the first resilient bands is configured to provide support to a torso of a user of the article of clothing, the second resilient band is configured to position a first arm of the user in a raised and bent position, and the third resilient band is configured to position, and a second arm of the user in a raised and extended position.
